(19) United States
(12) Patent Application Publication
(10) Pub. No.: US 2007/0115268 A1
(43) Pub. Date: May 24, 2007

(54) Display with window assembly and mobile phone having the same

(76) Inventors: Jin Seok Jang, Ulsan (KR); Jae Ho Jung, Ulsan (KR); Yong Seok Kim, Ulsan (KR); Hyo Shin Song, Ulsan (KR); Hwan Soo Lim, Ulsan (KR)

Correspondence Address: CHRISTIE, PARKER & HALE, LLP, PO BOX 7068, PASADENA, CA, 91109-7068, US

(21) Appl. No.: 11/544,198

(22) Filed: Oct. 5, 2006

(30) Foreign Application Priority Data
Nov. 23, 2005 (KR) 10-2005-0112591

(51) Int. Cl. G09G 3/22

(52) U.S. Cl. 345/183; 345/156

(57) ABSTRACT

A display with a window assembly includes a case unit with an opening and having a stepped part in at least one side of an edge of the opening; a window member having a first surface coupled with the stepped part; a display unit closely adhered on a first side to a second surface of the window member; a backlight unit provided on a second side of the display unit, so as to project light to the display unit, the backlight unit having a housing unit for enclosing the display unit, and closely adhered to at least one portion of the window member that is not closely adhered to the display unit; and an adhesion unit arranged between the backlight unit and the window member to adhere the backlight unit and the window member to each other.

### CROSS-REFERENCE TO RELATED APPLICATIONS

This application claims priority to and the benefit of Korean Patent Application No. 2005-112591, filed on Nov. 23, 2005, in the Korean Intellectual Property Office, the entire content of which is incorporated herein by reference.

### BACKGROUND

Liquid crystal displays (LCDs) have been used as the displays in various electronic apparatuses including portable communication apparatuses such as cellular phones or PDA. A window is installed on a case of an electronic apparatus for protecting an LCD by isolating it from the outside. An opening is also formed on the case for exposing the LCD to the outside. In this case, the window is coupled with the opening to form a window assembly for a display, and therefore the LCD is protected while images can be viewed from the outside.

Hereinafter, a conventional window assembly in a display of a mobile phone will be described in detail, with reference to FIGS. 1 and 2.

FIG. 1 is an external perspective view showing a conventional mobile phone, and FIG. 2 is a schematic view showing a portion of the display shown in FIG. 1.

As shown in FIG. 1, a conventional mobile phone 1 essentially includes a display unit 100 displayed so that users can recognize certain signals; an input unit 200 for inputting display signals to the display unit 100, and a control unit (not shown in FIG. 1) for controlling the input signals of the input unit 200 and the display signals of the display unit 100.

Referring to FIG. 2, the display unit 100 of such a conventional mobile phone 1 includes a case 110; a window 130 installed in the case 110; a display unit 150 mounted between the window 130 and the case 110 to be installed inside of the mobile phone 1; and backlight unit 170 (so-called “BLU”).

The case 110 represents the bulk of the appearance of the mobile phone 1, wherein a predetermined opening is formed for showing images from the display unit 150 installed inside of the case 110 to the outside, and a stepped part 112 is formed along edges of the opening.

The window 130 is installed in the stepped part 112 of the case 110, and is designed to protect the display unit 150, installed inside of the case 110, from the outer environment.

The display unit 150 emits display signals by driving of the mobile phone 1 so that users can recognize the signals, and is arranged inside to correspond to a window 130 in the inside of the mobile phone 1, namely the inside of the case 110.

If the display unit 150 is installed inside of the case 110, the display unit 150 in this embodiment is received into a backlight unit 170 for projecting the light to the display unit 150, and the backlight unit 170 is adhered to an inner surface of the case 110 by, for example, a tape 190, to fix the display unit 150 which is received into the backlight unit 170.

A gap g1 is generated between the window 130 and the display unit 150, which are both installed in the stepped part 112 of the case 110. The gap g1 is an important factor in determinaing a thickness t1 of the display unit 100 in the mobile phone 1.

However, there has been a demand that the gap g1 of the display unit 100 should be reduced to meet an increasing demand for thin mobile phone 1. Also, the mobile phone 1 with such a structure has a poor impact resistance against impacts applied from the outside and allows the backlight unit 170 to be in direct contact with the inside of the case 110. An adhesion space, therefore, may not be sufficiently secured and its yield may be lowered due to its complicated process.

### SUMMARY OF THE INVENTION

A display with a window assembly includes a case unit formed with an opening and having a stepped part in at least one side of an edge of the opening; a window member having a first surface coupled with the stepped part; a display unit closely adhered on a first side to a second surface of the window member different from the first surface of the window member; a backlight unit provided on a second side of the display unit that is different from the first side of the display unit, so as to project light to the display unit, the backlight unit having a housing unit for enclosing the display unit, and closely adhered to at least one portion of the window member that is not closely adhered to the display unit; and an adhesion unit arranged between the backlight unit and the window member to adhere the backlight unit and the window member to each other.

An outer circumference of the window member may correspond to an inner circumference of the backlight unit that closely adheres to a peripheral surface of the window member. The adhesion unit may also be arranged to surround at least one side of the backlight unit that is closely provided to the window member. In one embodiment, the adhesion unit is further arranged between the display unit and the window member. In another embodiment, the adhesion unit is arranged in the closely adhered sides between the display unit and the window member, and between the backlight unit and the window member so that an opening can be formed from the display unit to the window member, wherein the opening is smaller than or substantially identical to outer dimensions of the backlight unit or the window member.

Facing surfaces of the window member, the display unit, and the backlight unit have a rectangular shape, in some embodiments, and the adhesion unit is formed along an outermost side on each closely adhered surface between the backlight unit and the window member so that a circumference of the adhesion unit can be substantially identical to or smaller than outer dimensions of the backlight unit or the window member, and the adhesion unit is arranged to correspond to the facing surfaces of the display unit or the window member.

The adhesion unit may also be formed along an outermost side on each closely adhered surface between the backlight unit and the window member so that a circumference of the adhesion unit can be substantially identical to or smaller than outer dimensions of the backlight unit or the window member, and the adhesion unit has an inner portion to which at least a portion of the display unit is exposed.

The window member may have a stepped part formed to correspond to the opening of the case unit in which the stepped part of the case is formed, and may be formed so that it can transmit light at least over a visible light wavelength.

The display unit may be a liquid crystal display.

An embodiment of a mobile phone includes the display with a window assembly as discussed above; an input unit for transmitting input signals to input display signals into the display; and a control unit for controlling the input signal of the input unit and the display signals of the display.

Another embodiment of the display with a window assembly includes a case unit formed with an opening and having a stepped part in at least one side of an edge of the opening; a window member having a first surface coupled with the stepped part; a display unit closely adhered on a first side to a second surface of the window member different from the first surface of the window member; a backlight unit provided on a second side of the display unit that is different from the first side of the display unit, so as to project light to the display unit, the backlight unit having a housing unit for enclosing the display unit, and closely adhered to at least one portion of the window member that is not closely adhered to the display unit; and an adhesion unit arranged between the backlight unit and the case unit to adhere the backlight unit and the case unit to each other.

### BRIEF DESCRIPTION OF THE DRAWINGS

These and/or other aspects and features of the invention will become apparent and more readily appreciated from the following description of examples of embodiments, taken in conjunction with the accompanying drawings of which:

FIG. 1 is an external perspective view showing a conventional mobile phone;

FIG. 2 is a schematic cross-sectional view showing a portion of a display shown in FIG. 1;

FIGS. 3A to 3C are partial schematic views showing various embodiments of a display with a window assembly according to the present invention;

FIGS. 4A to 4H are partial plane views schematically showing various embodiments of an adhesion unit provided on a display unit and a backlight unit in a display with a window assembly according to the present invention;

FIGS. 5A to 5D are partial cross-sectional views schematically showing various embodiments of a display with a window assembly according to the, present invention;

FIGS. 6A to 6C are partial cross-sectional views schematically showing various embodiments of an adhesion unit in a display with a window assembly according to the present invention; and

FIG. 7 is an external perspective view showing an embodiment of a mobile phone having a display with a window assembly according to the present invention.

### DETAILED DESCRIPTION

Hereinafter, a display with a window assembly according to examples of embodiments of the present invention will be described with reference to the accompanying drawings.

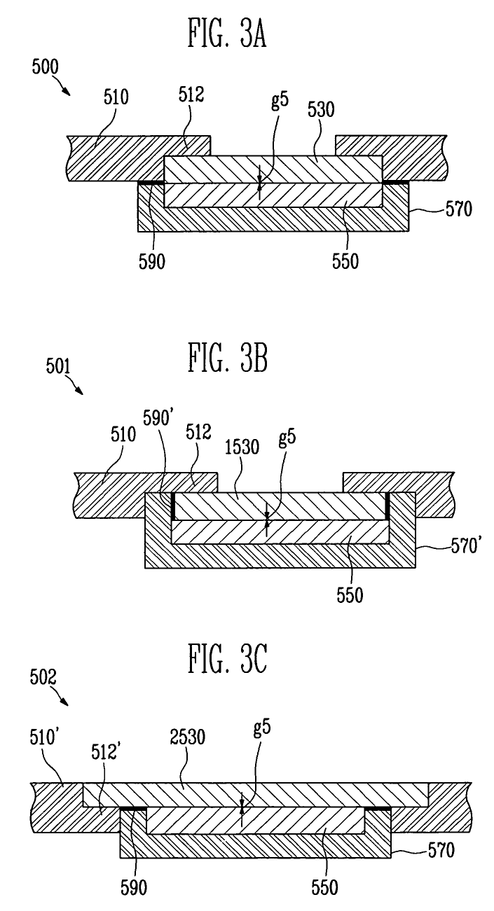

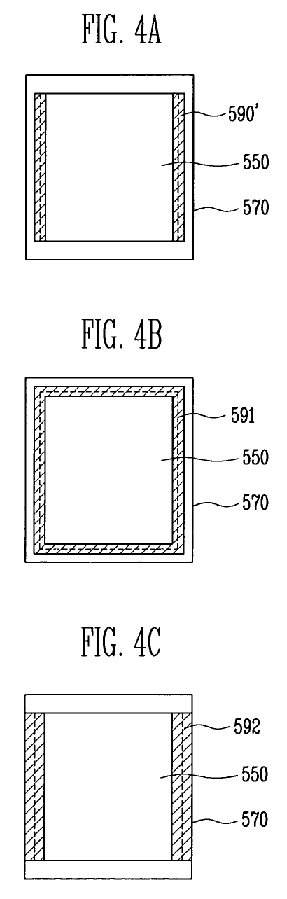

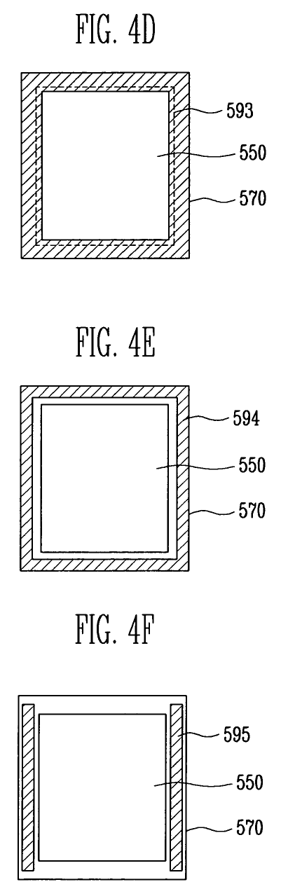

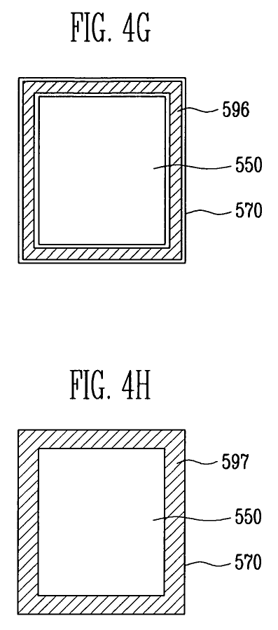

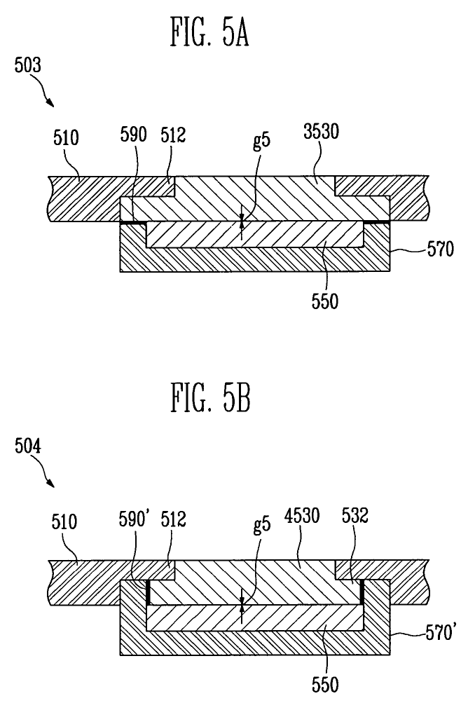

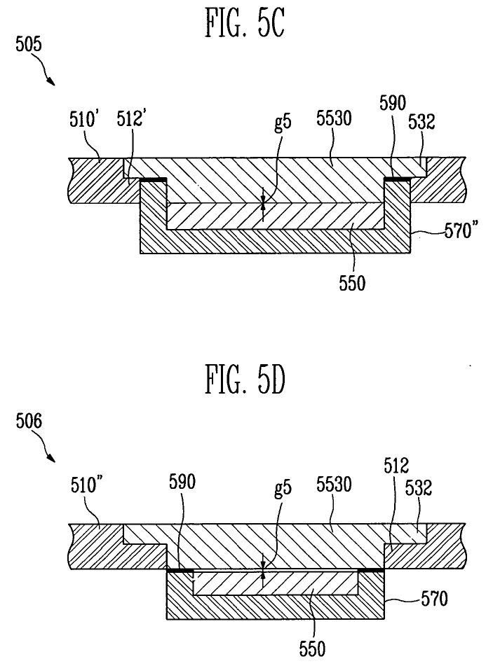

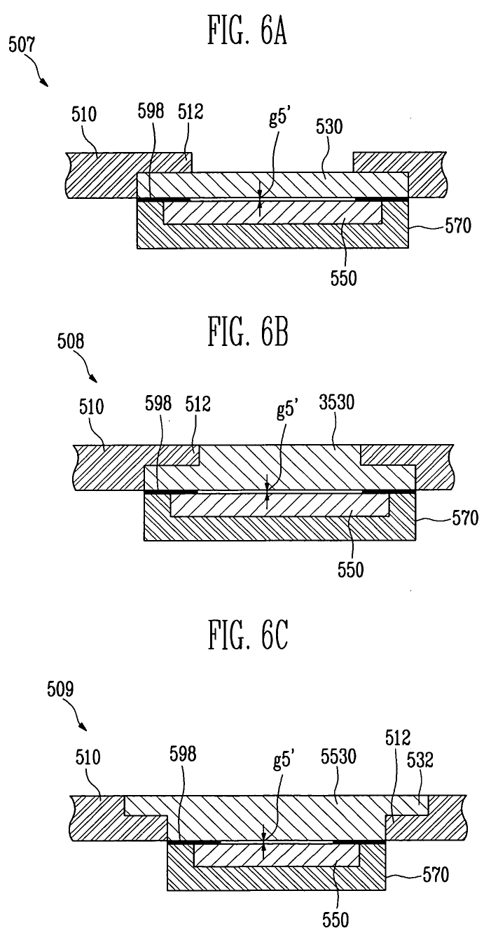

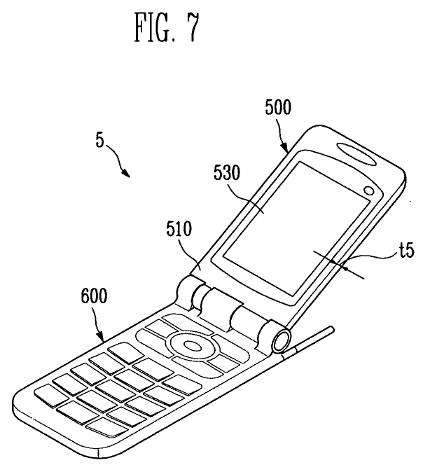

FIGS. 3A to 3C are partial schematic views showing various embodiments of a display with a window assembly according to the present invention, FIGS. 4A to 4H are partial plane views schematically showing various embodiments of an adhesion unit provided on a display unit and a backlight unit in a display with a window assembly according to the present invention, FIGS. 5A to 5D are partial cross-sectional views schematically showing various embodiments of a display with a window assembly according to the present invention, and FIGS. 6A to 6C are partial cross-sectional views schematically showing various embodiments of an adhesion unit in a display with a window assembly according to the present invention.

As shown in FIGS. 3A-6C, a display with a window assembly 500 to 509 according to various embodiments of the present invention includes a case unit 510 to 510″ having a predetermined opening formed thereon and a stepped part 512 to 512′ formed in one surface of the opening edges. A first surface of a window member 530, 1530, 2530, 3530, 4530, 5530 is coupled with the stepped part 512 to 512′ and a second surface of the window member is closely adhered to a display unit 550 . A backlight unit 570 to 570′″ (BLU) is provided on another surface of the display unit 550 than is the window member so as to project light toward the display unit 550. The backlight unit 570 to 570′″ has a housing unit for enclosing the display unit 550. The backlight unit 570 is closely adhered to at least one portion of the window member other than the portion on which the display unit 550 is closely adhered. An adhesion unit 591 to 598 is arranged between the backlight unit 570 to 570′″ and the window member to adhere them to each other. In one embodiment, the adhesion unit 590 is arranged between the backlight unit 570 and the case unit 510 to adhere them to each other.

A predetermined opening is formed in the case unit 510 to 510″, and the opening is formed to display pictures to users. In the case in which the opening is formed, a predetermined stepped part 512 to 512′ is formed along edges of the opening formed thereof, and the stepped part is formed entirely along the opening edge. The invention, however, is not limited thereto, and the stepped part may be formed at least in a portion of the opening edge. The stepped part is formed in one side of opening of the case 510 to 510″, and a window is then coupled with the stepped part. Although not shown in FIGS. 3A to 3C, different shapes other than the stepped part 512 to 512′ shown may be realized according to desired characteristics. For example, windows may be installed in both sides of the case, or grooves may be formed in an inner surface of the opening edge formed in the case to fix the window member to the grooves. It is also possible for the window member to be closely coupled with the grooves, and the stepped part may be entirely or partially formed on the edge of the opening formed in the case. This arrangement may be modified depending on the desired characteristics.

The window is made of materials capable of transmitting light at least over the visible light wavelength, and display signals emitted from the display unit 550 are transmitted through the window so that users can recognize the display signals.

The display unit 550 is installed inside of the case, and formed to correspond to the opening of the case and the window so that it can emit display signals for users to recognize. The display unit 550 may be a liquid crystal display (LCD) composed of liquid crystals, but may also be any suitable display devices, such as are used for other applications.

One side of the display unit 550 is closely provided with one side of the window. The display unit 550, more specifically a circumference of the display unit 550, is smaller than or identical to a circumference of the window which closely adheres to the display unit 550. In the display unit 550 and the window 530, 1530, 4530, 5530 which are closely adhered to each other, circumferences of each of the closely adhered surfaces precisely correspond to each other upon closely adhering to each other if they have the same circumferences, as seen in FIGS. 3A, 3B, 5B, and 5C. Alternatively, center points of the display unit 550 and the window 530, 2530, 3530, 5530 are in agreement with each other for each circumference upon closely adhering to each other if a circumference of the display unit 550 is smaller than that of the window, as shown in FIGS. 3C, 5A, 5D, and 6A-6C.

In order to display the display signals from the display unit 550, a backlight unit 570 to 570″ is provided next to the display unit 550, more specifically on a different side of the display unit 550 from the window. Therefore, the light at least over the visible light wavelength may be projected into the display unit 550. Here, the different side is a side opposite to the surface of the window to which the display unit 550 is closely adhered.

The backlight unit 570 to 570″ has a housing unit and, in some embodiments, the display unit 550 is shaped as a rectangular hexahedron with outer surfaces. One outer surface is closely adhered to the window, and another outer surface is adjacent to the backlight unit 570 to 570″.

The housing unit provided in the backlight unit 570 to 570″ is closely adhered to at least one of the surfaces of the window, except for the embodiment shown in FIG. 3A, where it is closely adhered to the case unit 510. The side of the window that adheres to the display unit 550 also closely adheres to the backlight unit 570 to 570″ if a circumference of the adhering surface of the display unit 550 is smaller than a circumference of the window, as shown in FIGS. 3A, 3C, 5A, 5D, 6A, 6B, and 6C.

A circumference of the window in FIGS. 3B, 5B, and 5C, in contrast, is substantially identical to that of the surface closely adhered to the display unit 550 of the window, and the peripheral surfaces of the window that are adjacent to the surface closely adhering to the display unit 550 are enclosed by the housing unit.

When a circumference of the window surface closely adhered to the display unit 550 is substantially identical to that of the closely adhered surface of the display unit 550, four peripheral surfaces of the window are enclosed by the housing unit of the backlight unit 570 to 570″, rather than the one surface closely adhered to the window, to which the four peripheral surfaces of the window are adjacent.

The housing unit provided in the backlight unit 570 to 570″ may be variously modified according to desired rigidity and functions, and therefore it is shown in the accompanying drawings of this specification without distinction of the backlight unit 570 to 570″.

When the display unit 550 and the window enclosed by the housing unit of the backlight unit 570 to 570″ are closely adhered to each other, an adhesion unit 590′, 591 to 598 is provided between the window and the housing unit of the backlight unit 570 to 570″ so that the window and the housing unit of the backlight unit 570 to 570″ can be closely adhered to each other, wherein the adhesion unit is a tape, and may be other adhesion units having the same functions.

The tape provided between the window and the housing unit of the backlight unit 570 may be formed on a surface wherein the housing unit of the backlight unit 570 is closely adhered to the window (FIGS. 4E to 4H) so that its outer dimension can be smaller than (FIG. 4F, FIG. 4G) or identical to (FIG. 4E, FIG. 4H) that of the housing unit of the backlight unit 570 to 570″. The display unit 550 forms a predetermined open or closed opening so that display signals displayed by the display unit 550 can be recognized by the users by means of the window and the opening of the case, as shown in FIGS. 4A to 4H.

In this case, a gap g5 is formed between the window and the display unit, and the gap g5 may have a smaller value than a gap g1 in a conventional display 100 shown in FIG. 2.

As shown in FIGS. 6A-6C, the tape 598 provided between the window and the housing unit of the backlight unit 570 may be formed over the surface where the housing unit of the backlight unit 570 is closely adhered to the window, and also the surface where the display unit 550 is closely adhered to the window (FIGS. 4A to 4D) so that its outer dimension can be smaller than (FIG. 4A, FIG. 4B), or identical to (FIG. 4C, FIG. 4D) that of the housing unit of the backlight unit 570, and the display unit 550 forms a predetermined open or closed opening so that display signals displayed by the display unit 550 can be recognized by the users by means of the window and the opening of the case 510.

In this case, a gap g5′ is formed between the window and the display unit 550, and the gap g5′ may have a smaller value than a gap g1 in a conventional display 100 shown in FIG. 2. At this time, the gap g5′ may have a higher value than the above gap g5 according to thickness of the tape 598 inserted between the display unit 550 and the window, or may have a structure having the gap g′ considering rigidity of the display 507 to 509.

Referring again to FIGS. 3A to 6C, for surfaces of the window, the display unit 550 and the housing unit of the backlight unit 570 to 570″, each having a rectangular shape, the tape is formed so that it can correspond to the most outer side (FIG. 4C, FIG. 4D, FIG. 4E and FIG. 4H) on the surfaces wherein the housing unit of the backlight unit 570 to 570″ is closely adhered to the window, or the housing unit of the backlight unit 570 to 570″ and the display unit 550 are closely adhered to the window 530, namely a circumference of the tape is formed so that its outer dimension can be identical to that of the housing unit of the backlight unit 570 to 570″ and/or the window, and it may also be formed to correspond to facing sides of the display unit 550 having a rectangular shape, as shown in FIG. 4C and 4H. The tape may also be formed to have a predetermined inner space within the circumference of the housing unit of the backlight unit having a rectangular shape, as shown in FIG. 4D, FIG. 4E and FIG. 4H. An alternate arrangement of the tape may be realized if the tape has a smaller outer dimension than that of the housing unit of the backlight unit, as shown in FIG. 4B and FIG. 4G.

In addition to such an arrangement, the aforementioned window may have a stepped part 532 so as to correspond to the stepped part 512 to 512′ formed in the case, and therefore it may be designed to fill the opening of the case, as shown in FIG. 5A to FIG. 5D and FIG. 6B to FIG. 6C.

The case may have an inward stepped part 512, as shown in FIG. 5A and FIG. 5B or an outward stepped part 512′, as shown in FIG. 5C and FIG. 5D. The window provided in the stepped part 512, 512′ according to each modified embodiment also has a stepped part 532 so that it can fill the opening of the case with a shape corresponding to the window, and the stepped part 512, 512′ of the case may be a more complicated stepped part in addition to the stepped part as shown in the figures. The stepped part 532 of the window may be also modified to correspond to the window.

The tape may be further provided between the display unit 550 and the window, as shown in FIGS. 4A to 4D and FIGS. 6A to 6C. In this case, the tape may be integrally or separately formed so that the tape provided between the backlight unit 570 to 570″ and the window can be further extended between the display unit 550 and the window.

In the modified embodiments of each display 500 to 509 as described above, the display has gaps g5, g5′ between the window 530 and the display unit 550, and the gaps g5, g5′ have a smaller value than the gap g1 in the conventional display 100 as shown in FIG. 2, and therefore it is possible to make the display thinner, and the display may be easily assembled by closely adhering the window and the housing unit of the backlight unit to each other, or adhering the housing unit of the backlight unit and the display unit 550 to each other using an adhesion unit. Accordingly, the display may be more easily assembled when compared to the conventional display 100 since an adhesion space is easily secured, and therefore its entire cost may be reduced.

Hereinafter, a mobile phone having the display with a window assembly according to an embodiment of the present invention will be described in detail with reference to the accompanying drawing.

FIG. 7 is an external perspective view showing a mobile phone having the display with a window assembly according to an embodiment of the present invention.

The mobile phone 5 having the display with a window assembly according to this embodiment of the present invention includes the display with a window assembly 500; an input unit 600 formed to input display signals into the display 500; and a control unit (not shown) for controlling the input signals of the input unit 600 and the display signals of the display.

The display 500 is formed as a display 500 having gaps g5 or g5′ between the window 530 and the display unit 550, and an input unit 600 is formed to input display signals into the display 500. The input unit 600 is a conventional input unit 800, and includes a keypad for manual works of users, a sound-recognition unit for sound, a receiving unit for communication signals, an incident light-recognition unit for a camera attached to a phone 5, and other members for generating input signals in general.

A conventional control unit is formed in the phone 5 so that it can control the input signals of the input unit 600 and the display signals of the display 500.

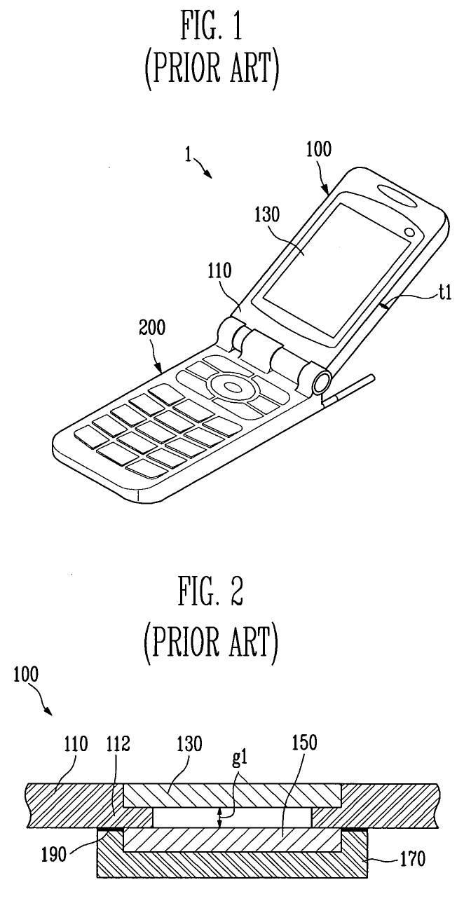

The phone 5 arranged thus may have a shape as shown in FIG. 7, and have other shapes having the display 500, the input unit 600 and the control unit. The thickness t5 of the phone 5, more specifically the thickness t5 formed as the display 500 in the phone 5 may be thinner than the thickness t1 in the conventional phone 1 as shown in FIG. 1 due to the gaps g5 or g5′ between the window 530 and the display unit 550 in the display 500.

Although a few embodiments of the present invention have been shown and described in detail, it would be appreciated by those skilled in the art that the descriptions proposed herein are just examples for the purpose of illustrations only, not intended to limit the scope of the invention. It should be also understood that other equivalents and modifications could be made thereto without departing from the spirit and scope of the invention, as defined in the appended claims and their equivalents.

As described above, according to some embodiments of the present invention, the display with a window assembly and the mobile phone having the same may reduce the manufacturing cost since the final products becomes thinner, and are also easily assembled.

Various embodiments of the display with a window assembly and the mobile phone having the same may improve an impact resistance against impacts applied from the outside, and smoothly carry out its manufacturing process to increase its yield by securing the space of the adhesion.

What is claimed is:

1. A display with a window assembly comprising:
a case unit formed with an opening and having a stepped part in at least one side of an edge of the opening;
a window member having a first surface coupled with the stepped part;
a display unit closely adhered on a first side to a second surface of the window member different from the first surface of the window member;
a backlight unit provided on a second side of the display unit that is different from the first side of the display unit, so as to project light to the display unit, the backlight unit having a housing unit for enclosing the display unit, and closely adhered to at least one portion of the window member that is not closely adhered to the display unit; and
an adhesion unit arranged between the backlight unit and the window member to adhere the backlight unit and the window member to each other.

2. The display with a window assembly according to claim 1, wherein an outer circumference of the window member corresponds to an inner circumference of the backlight unit that closely adheres to a peripheral surface of the window member.

3. The display with a window assembly according to claim 1, wherein the adhesion unit is arranged to surround at least one side of the backlight unit that is closely provided to the window member.

4. The display with a window assembly according to claim 3, wherein the adhesion unit is further arranged between the display unit and the window member.

5. The display with a window assembly according to claim 3, wherein the adhesion unit is arranged in the closely adhered sides between the display unit and the window member, and between the backlight unit and the window member so that an opening can be formed from the display unit to the window member, wherein the opening is smaller than or substantially identical to outer dimensions of the backlight unit or the window member.

6. The display with a window assembly according to claim 5, wherein facing surfaces of the window member, the display unit, and the backlight unit have a rectangular shape, and the adhesion unit is formed along an outermost side on each closely adhered surface between the backlight unit and the window member so that a circumference of the adhesion unit can be substantially identical to outer dimensions of the backlight unit or the window member, and the adhesion unit is arranged to correspond to the facing surfaces of the display unit or the window member.

7. The display with a window assembly according to claim 5, wherein the adhesion unit is formed along an outermost side on each closely adhered surface between the backlight unit and the window member so that a circumference of the adhesion unit can be substantially identical to outer dimensions of the backlight unit or the window member, and the adhesion unit has an inner portion to which at least a portion of the display unit is exposed.

8. The display with a window assembly according to claim 5, wherein facing surfaces of the window member, the display unit, and the backlight unit have a rectangular shape, and the adhesion unit is formed along an outermost side on each closely adhered surface between the backlight unit and the window member so that a circumference of the adhesion unit can be smaller than outer dimensions of the backlight unit or the window member, and the adhesion unit is arranged to correspond to the facing sides of the display unit or the window member.

9. The display with a window assembly according to claim 5, wherein the adhesion unit is formed along an outermost side on each closely adhered surface between the backlight unit and the window member so that a circumference of the adhesion unit can be smaller than outer dimensions of the backlight unit or the window member, and the adhesion unit has an inner portion to which at least a portion of the display unit is exposed.

10. The display with a window assembly according to claim 1, wherein the window member has a stepped part formed to correspond to the opening of the case unit in which the stepped part of the case is formed.

11. The display with a window assembly according to claim 1, wherein the display unit is a liquid crystal display.

12. The display with a window assembly according to claim 1, wherein the window member is formed so that it can transmit light at least over a visible light wavelength.

13. A mobile phone comprising:
the display with a window assembly as defined in claim 1;
an input unit for transmitting input signals to input display signals into the display; and
a control unit for controlling the input signal of the input unit and the display signals of the display.

14. A display with a window assembly comprising:
a case unit formed with an opening and having a stepped part in at least one side of an edge of the opening;
a window member having a first surface coupled with the stepped part;
a display unit closely adhered on a first side to a second surface of the window member different from the first surface of the window member;
a backlight unit provided on a second side of the display unit that is different from the first side of the display unit, so as to project light to the display unit, the backlight unit having a housing unit for enclosing the display unit, and closely adhered to at least one portion of the window member that is not closely adhered to the display unit; and
an adhesion unit arranged between the backlight unit and the case unit to adhere the backlight unit and the case unit to each other.
